(19) United States
(12) Patent Application Publication
(10) Pub. No.: US 2007/0139518 A1
(43) Pub. Date: Jun. 21, 2007

(54) IMAGE-CAPTURING AND DATA-STORING SYSTEM WITH DATA-COMPRESSING FUNCTION AND RELATED METHOD TO PROCESS IMAGE DATA

(76) Inventor: Ming-Chih Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/306,114

(22) Filed: Dec. 16, 2005

(51) Int. Cl. H04N 7/14; H04N 5/445

(52) U.S. Cl. 348/14.13; 348/568

(57) ABSTRACT

An image-capturing and data-storing system includes a plurality of image-capturing devices for capturing images and generating corresponding formatted data, a first network-attached storage (NAS) device coupled via a network to the image-capturing devices for storing the formatted data transferred through the network, and a second NAS device coupled via the network to the first NAS device for compressing the formatted data transferred through the network and storing the compressed data generated by the second NAS device.

### BACKGROUND OF THE INVENTION

1. Field of the Invention

The present invention relates to an image-capturing and data-storing system, and more particularly, to an image-capturing and data-storing system with data compression function.

2. Description of the Prior Art

Please refer to FIG. 1 for a functional block diagram of a prior art image-capturing and data-storing system 10. The system 10 includes an image-capturing device 12, a network-attached storage (NAS) server 14, and a transmitting network 16 coupled between the image-capturing device 12 and the NAS server 14.

The image-capturing device 12 can capture images and generate formatted data corresponding to the captured images. For example, the image-capturing device 12 can generate formatted data based on joint photographic experts group (JPEG) or joint bi-level image experts group (JBIG) schemes. The formatted data generated by the image-capturing device 12 is transmitted through the transmitting network 16 and stored in the NAS server 14.

As its name suggests, the NAS server 14 is an intelligent and self-sufficient data-storing device that is connected directly to a local area network (LAN). Correspondingly, the transmitting network 16 can be a local area network. The NAS server 14 can transmit data between different network standard protocols, such as TCP/IP (Transmission Control Protocol/Internet Protocol) or IPX (Internet Packet Exchange) which utilize industry standard file sharing protocols like SMB (Server Message Block), CIFS (Common Internet File System), NFS (Network Control Protocol), AFP (Apple File Protocol), NFS (Network File System), or HTTP (Hypertext Transfer Protocol), etc.

In the system 10, the space required for data storage in the NAS server 14 is influenced by the data compression techniques adopted by the image-capturing device 12. Therefore, when the image-capturing device 12 uses a data compression method which generates formatted data of larger size, more space for data storage is required for the NAS server 14, which also results in higher manufacturing cost.

### SUMMARY OF THE INVENTION

It is therefore a primary objective of the claimed invention to provide an image-capturing and data-storing system with data compression function in order to solve the problems of the prior art.

The claimed invention provides an image-capturing and data-storing system with data compression function comprising a plurality of image-capturing devices for capturing images and generating formatted data corresponding to the captured images; a first network-attached storage device coupled to the plurality of image-capturing devices through a network for storing formatted data transmitted from the network; and a second network-attached storage device coupled to the first network-attached storage device through the network for compressing formatted data sent from the first network-attached storage device through the network and for storing data having been compressed by the second network-attached storage device.

The claimed invention further provides an image-processing method comprising capturing images using a plurality of image-capturing devices and generating formatted data corresponding to the captured images; transmitting the formatted data generated by the plurality of image-capturing devices to a first network-attached storage device through a network; storing the formatted data transmitted through the network in the first network-attached storage device; transmitting the formatted data stored in the first network-attached storage device to a second network-attached storage device through the network; and compressing the formatted data transmitted from the first network-attached storage device through the network using the second network-attached storage device and storing data having been compressed by the second network-attached storage device.

The claimed invention further provides an image-capturing and data-storing system with data compression function comprising an image-capturing device for capturing images and generating formatted data corresponding to the captured images; and a first network-attached storage device coupled to the image-capturing device through a network, the first network-attached storage device comprising: a first compression unit for compressing formatted data sent from the image-capturing device; and a data-storing unit for storing data having been compressed by the first compression unit.

The claimed invention further provides an image-processing method comprising capturing images using an image-capturing device and generating formatted data corresponding to the captured images; transmitting the formatted data generated by the image-capturing device through a network; compressing a first part of the formatted data transmitted through the network using a first compression unit of a first network-attached storage device; and storing the first part of formatted data having been compressed by the first network-attached storage device and a second part of formatted data not compressed by the first network-attached storage device in a first data-storing unit of the first network-attached storage device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a prior art image-capturing and data-storing system.

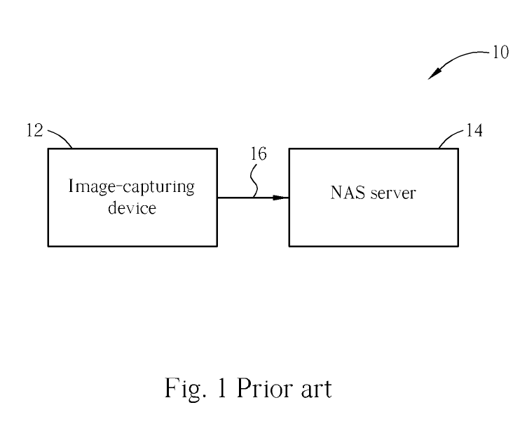

FIG. 2 is a functional block diagram of an image-capturing and data-storing system according to a first embodiment of the present invention.

FIG. 3 is a functional block diagram of an image-capturing and data-storing system according to a second embodiment of the present invention.

### DETAILED DESCRIPTION

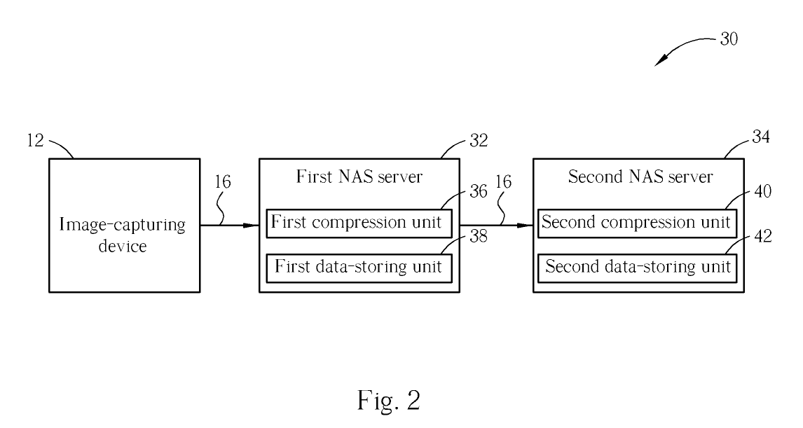

Please refer to FIG. 2 for a functional block diagram of an image-capturing & data-storing system 30 according to a first embodiment of the present invention. The system 30 includes an image-capturing device 12, a transmitting network 16, a first network-attached storage (NAS) server 32 coupled to the transmitting network 16, and a second NAS server 34 also coupled to the transmitting network 16. In the system 30, the first NAS server 32 includes a first compression unit 36 and a first data-storing unit 38, and the second NAS server 34 includes a second compression unit 40 and a second data-storing unit 42. The first compression unit 36 of the first NAS server 32 only performs data compression on a first part of the formatted data stored in the first data-storing unit 38 (such as the first 50 percent of the formatted data), and a remaining second part of the formatted data (such as the last 50 percent of the formatted data) stored in the first data-storing unit 38 is transmitted to the second NAS server 34 through the transmitting network 16. The second NAS server 34 then compresses the second part of the formatted data and thereby performs clustering and simultaneous data compression in the system 30.

In the first embodiment of the present invention, the first part of the formatted data compressed by the first compression unit 36 of the first NAS server 32 not only can be stored in the first data-storing unit 38, it can also be transmitted to the second storage unit 42 of the second NAS server 34 through the transmitting network 16 for remote backup.

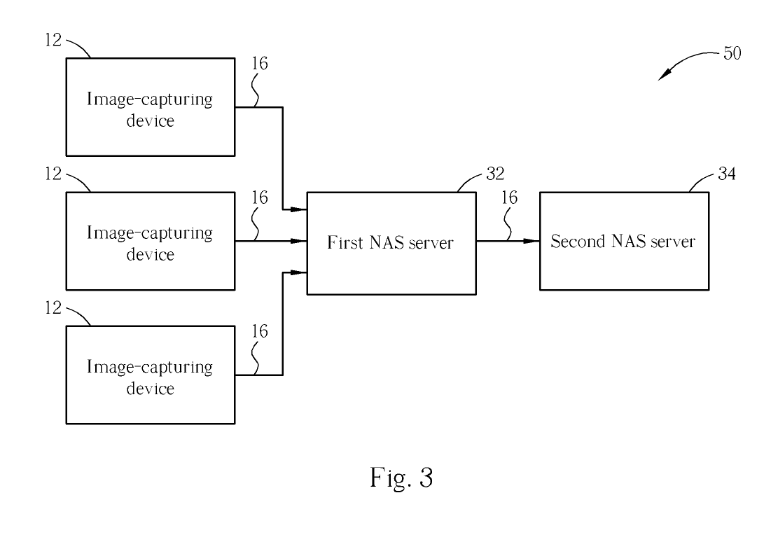

Generally speaking, an image-capturing and data-storing system usually includes more than one image-capturing device. Please refer to FIG. 3 for a functional block diagram of an image-capturing and data-storing system 50 according to a second embodiment of the present invention. The system 50 includes three image-capturing devices 12. In the system 50, the first NAS server 32 is used for receiving formatted data transmitted from the image-capturing devices 12 and for reducing the load of the first NAS server 32. In other words, the first NAS server 32 is not required to perform data compression and all tasks of data compression in the system 50 are handled by the second NAS server 34. To be specific, the first NAS server 32 transmits the formatted data sent through the transmitting network 16 to the second NAS server 34, and the second NAS server 34 compresses the received formatted data.

Consequently, though coupled to multiple image-capturing devices 12, the first NAS server 32 of the system 50 can still have plenty of time to receive the formatted data sent through the transmitting network 16. Since the second NAS server 34 stores the compressed formatted data of smaller size, a user can reduce the search time by logging into the second NAS server 34 before logging into the first NAS server 32 (which stores the uncompressed formatted data of larger size). Equivalently speaking, the compressed formatted data stored in the second NAS server 34 can be viewed as catalogues or indexes. The user can search for certain formatted data in the second NAS server 34, and then access the corresponding complete formatted data in the first NAS server 32. The system 50 can also be coupled to more levels of NAS servers (such as a third NAS server, a fourth NAS server, etc) using the transmitting network 16 for converting data between different compression formats.

In the second embodiment of the present invention, the first NAS server 32 does not perform data compression and can therefore be replaced with the NAS server 14, which does not provide a data compression function, of the system 10.

Compared to the prior art, the image-capturing and data-storing system of the present invention not only includes a plurality of image-capturing devices and a first NAS server, but it also includes a second NAS server. Since the second NAS server can perform data compression, the first NAS server can have plenty of time to receive the formatted data sent through the transmitting network 16 when coupled to many image-capturing devices.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image-capturing and data-storing system with data compression function comprising:
a plurality of image-capturing devices for capturing images and generating formatted data corresponding to the captured images;
a first network-attached storage device coupled to the plurality of image-capturing devices through a network for storing formatted data transmitted from the network; and
a second network-attached storage device coupled to the first network attached storage device through the network for compressing formatted data sent from the first network attached storage device through the network and for storing data having been compressed by the second network attached storage device.

2. The image-capturing and data-storing system of claim 1 further comprising an Nth network-attached storage device coupled to an (N−1)th network-attached storage device through the network for compressing formatted data sent by the (N−1)th network-attached storage device through the network and for storing data having been compressed by the Nth network attached storage device, wherein N is an integer larger than 2.

3. An image-processing method comprising:
capturing images using a plurality of image-capturing devices and generating formatted data corresponding to the captured images;
transmitting the formatted data generated by the plurality of image-capturing devices to a first network-attached storage device through a network;
storing the formatted data transmitted through the network in the first network-attached storage device;
transmitting the formatted data stored in the first network-attached storage device to a second network-attached storage device through the network; and
compressing the formatted data transmitted from the first network-attached storage device through the network using the second network-attached storage device and storing data having been compressed by the second network-attached storage device.

4. The method of claim 3 further comprising:
transmitting formatted data stored in an (N−1)th network-attached storage device to an Nth network-attached storage device through the network; and
compressing the formatted data transmitted from the (N−1)th network-attached storage device through the network using the Nth network-attached storage device, and storing data having been compressed by the Nth network-attached storage device, wherein N is an integer larger than 2.

5. An image-capturing and data-storing system with data compression function comprising:
an image-capturing device for capturing images and generating formatted data corresponding to the captured images; and
a first network-attached storage device coupled to the image-capturing device through a network, the first network-attached storage device comprising:
a first compression unit for compressing formatted data sent from the image-capturing device; and
a data-storing unit for storing data having been compressed by the first compression unit.

6. The image-capturing and data-storing system of claim 5 further comprising:
an Nth network-attached storage device comprising an Nth compression unit and an Nth data-storing unit; and
an (N−1)th network-attached storage device coupled to the Nth network-attached storage device through the network, the (N−1)th network-attached storage device comprising an (N−1)th compression unit and an (N−1)th data-storing unit for storing formatted data sent through the network and for storing data having been compressed by the (N−1)th compression unit of the (N−1)th network-attached storage device, wherein N is an integer larger than 1.

7. An image-processing method comprising:
capturing images using an image-capturing device and generating formatted data corresponding to the captured images;
transmitting the formatted data generated by the image-capturing device through a network;
compressing a first part of the formatted data transmitted through the network using a first compression unit of a first network-attached storage device; and
storing the first part of formatted data having been compressed by the first network-attached storage device and a second part of formatted data not compressed by the first network-attached storage device in a first data-storing unit of the first network-attached storage device.

8. The method of claim 4 further comprising:
transmitting uncompressed formatted data stored in an (N−1)th network-attached storage device to an Nth network-attached storage device through the network;
compressing the uncompressed formatted data transmitted through the network using an Nth compression unit of the Nth network-attached storage device, and
storing data having been compressed by the Nth network-attached storage device and uncompressed formatted data transmitted from the (N−1)th network-attached storage device through the network in an Nth data-storing unit of the Nth network-attached storage device, wherein N is an integer larger than 1.

9. The method of claim 8 further comprising:
transmitting the data having been compressed by the Nth compression unit of the Nth network-attached storage device to the (N−1)th network-attached storage device through the network; and
storing the data having been compressed by the Nth compression unit of the Nth network-attached storage device in the (N−1)th data-storing unit of the (N−1)th network-attached storage device.

10. The method of claim 8 further comprising:
transmitting the data having been compressed by the (N−1)th compression unit of the (N−1)th network-attached storage device to the Nth data-storing unit of the Nth network-attached storage device through the network; and
storing the data having been compressed by the (N−1)th compression unit of the (N−1)th network-attached storage device in the Nth data-storing unit of the Nth network-attached storage device.
